(19) United States
(12) Patent Application Publication
(10) Pub. No.: US 2006/0025202 A1
(43) Pub. Date: Feb. 2, 2006

(54) Gaming machine

(75) Inventors: Kazunobu Sato, Tokyo (JP); Masahiro Yoshida, Tokyo (JP)

Correspondence Address: ARENT FOX PLLC, 1050 CONNECTICUT AVENUE, N.W., SUITE 400, WASHINGTON, DC, 20036, US

(73) Assignee: ARUZE Corp.

(21) Appl. No.: 11/185,778

(22) Filed: Jul. 21, 2005

(30) Foreign Application Priority Data
Jul. 28, 2004 (JP) 2004-220715

(51) Int. Cl. A63F 13/00

(52) U.S. Cl. 463/20

(57) ABSTRACT

In the gaming machine, it is provided the variable display device having a plurality of variable display portions in each of which a plurality of symbols are variably displayed, and the number measurement device measures a number of a specific stop symbol which is stopped and displayed in each of the variable display portions among the stop symbols determined by the symbol determination device after the game mode shifts to the special game mode and the specific shift device shifts the game mode from the special game mode to the specific game mode when the number determination device determines that the number of the specific stop symbol reaches to the predetermined determination number.

### CROSS-REFERENCE TO THE RELATED APPLICATION (S)

This application is based upon and claims a priority from the prior Japanese Patent Application No. 2004-220715 filed on Jul. 28, 2004, the entire contents of which are incorporated herein by reference.

### BACKGROUND OF THE INVENTION

1. Field of the Invention

The present invention relates to a gaming machine with a variable display device in which a plurality of variable display portions, each conducting variable display of plural symbols, are provided.

2. Description of Related Art

Conventionally, it is well-known a slot machine as a gaming machine, in which game media such as medals or coins (hereinafter, abbreviated as “coins”) used in a game are paid out corresponding to a winning prize contents in the game. In such slot machine, a plurality of reels (mechanical reels) on each outer periphery of which symbols are formed are provided and such reels are rotated when a player conducts a predetermined operation and it is determined whether a winning prize in the game is obtained or not and a prize mode, based on a symbol combination (hereinafter, abbreviated as “symbol pattern”) of the reels stopped at predetermined windows when each of reels is stopped. And among the slot machines, there is a gaming machine (so-called, video slot machine) in which a plurality of variable display images of symbols are displayed on an image display device capable of displaying game images used in the game and it is determined whether a winning prize in the game is obtained or not and a prize mode, based on a symbol combination displayed when the variable display (abbreviated as “scroll display”) is stopped.

Among such slot machines, there may be a slot machine having a special game mode beneficial for the player, in addition to a normal game mode according to which normal slot games can be done by utilizing the variable display images. For example, as shown in Unexamined Japanese Publication No. 2003-180908, there is a gaming machine in which a free game can be done in the special game mode through a predetermined number of free spin (free spin means an operation that the reels are automatically rotated or scrolled without newly inserting coins and the reels are stopped after a predetermined time elapses and coins are paid out corresponding to the symbol pattern which is stopped), and when more than three target symbols are stopped during one free game on a bet line, a number of free game is added.

However, in the above mentioned gaming machine, although there is variation that the number of free game is added when a specific condition is satisfied, the number of free game increases based on a simple condition and the number of free game is predetermined, therefore the game is apt to be monotonous. Accordingly, expectation of the player cannot be raised during the free game and interest of the player will be apt to incline to payout obtained in the free game.

### SUMMARY OF THE INVENTION

Therefore, in order to dissolve the above problems, the present invention has been done and has an object to provide a gaming machine in which, in addition to a game in a normal game mode, a game in both a special game mode and a specific game mode can be realized and expectation of a player can be raised during the special game mode, thereby interest for games can be raised.

In order to accomplish the above object, the present invention provides a gaming machine comprising:

a variable display device having a plurality of variable display portions in each of which a plurality of symbols are variably displayed;

a symbol determination device for determining stop symbols each of which is stopped in each of variable display portions;

a shift determination device for determining whether or not a shift condition to shift a game mode from a normal game mode to a special game mode is realized; and

a shift device for shifting the game mode from the normal game mode to the special game mode based on a determination result determined by the shift determination device;

the gaming machine further comprising:

a number measurement device for measuring a number of a specific stop symbol which is stopped and displayed in each of the variable display portions among the stop symbols determined by the symbol determination device after the game mode shifts to the special game mode; and

a number determination device for determining whether or not the number of the specific stop symbol measured by the number measurement device reaches to a predetermined determination number; and

a specific shift device for shifting the game mode from the special game mode to a specific game mode when the number determination device determines that the number of the specific stop symbol reaches to the predetermined determination number.

In the above gaming machine, the number measurement device measures a number of a specific stop symbol which is stopped and displayed in each of the variable display portions among the stop symbols determined by the symbol determination device after the game mode shifts to the special game mode, and when the number determination device determines that the number of the specific stop symbol reaches to the predetermined determination number, the specific shift device shifts the game mode from the special game mode to the specific game mode.

As mentioned, according to gaming machine of the present invention, expectation of the player who expects that the game mode shifts to the specific game mode from the special game mode after the game mode shifts to the special game mode, can be raised and fascination for games can be raised.

Further, according to the present invention, it is provided a gaming method comprising steps of

variably displaying a plurality of symbols in each of a plurality of variable display portions of a variable display device;

determining stop symbols stopped in each of the variable display portions;

determining whether or not a shift condition to shift a game mode from a normal game mode to a special game mode is realized;

shifting the game mode from the normal game mode to the special game mode based on a determination result determined in the determining step of the game mode;

measuring a number of a specific stop symbol which is stopped and displayed in each of the variable display portions among the stop symbols determined in the determining step of the stop symbol after the game mode shifts to the special game mode;

determining whether or not the number of the specific stop symbol measured in the measuring step reaches to a predetermined determination number; and

shifting the game mode from the special game mode to a specific game mode when it is determined in the determining step of the number of the specific stop symbol that the number of the specific stop symbol reaches to the predetermined determination number.

According to the gaming method of the present invention, expectation of the player who expects that the game mode shifts to the specific game mode from the special game mode after the game mode shifts to the special game mode, can be raised and fascination for games can be raised.

The above and further objects and novel features of the invention will more fully appear from the following detailed description when the same is read in connection with the accompanying drawings. It is to be expressly understood, however, that the drawings are for purpose of illustration only and not intended as a definition of the limits of the invention.

### BRIEF DESCRIPTION OF THE DRAWINGS

The accompanying drawings, which are incorporated in and constitute a part of this specification illustrate embodiments of the invention and, together with the description, serve to explain the objects, advantages and principles of the invention.

In the drawings,

FIG. 1 is a whole perspective view showing a video slot machine which is a gaming machine according to the embodiment,

FIG. 2 is an enlarged plan view showing a control panel,

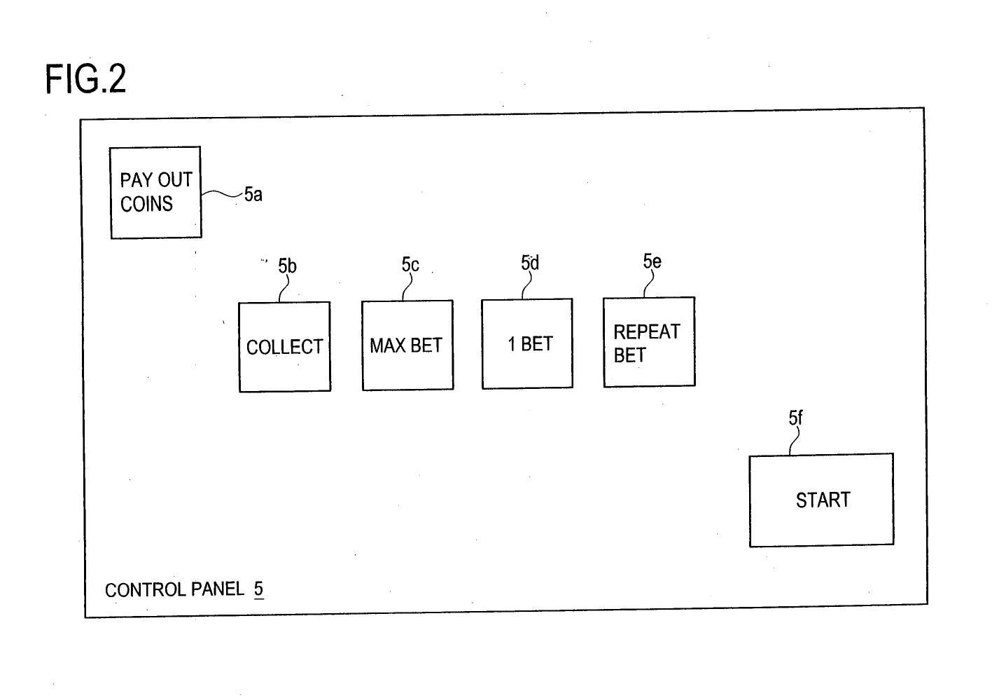

FIG. 3 is a block diagram showing an inner construction of the video slot machine,

FIG. 4 is a block diagram showing an image control circuit,

FIG. 5 is an explanatory view shown one example of an image displayed on a main display,

FIG. 6 is an explanatory view showing an example of a stop table referenced in a lottery process of a base game,

FIG. 7 is an explanatory view showing an example of a stop table referenced in a lottery process of a common free game,

FIG. 8 is a flowchart showing procedures in a main process conducted from a game start to a game termination in the slot machine, the procedures being shown by blocks divided into each procedure,

FIG. 9 is a flowchart showing procedures in the lottery process shown in FIG. 8,

FIG. 10 is a flowchart showing procedures in a bonus game process shown in FIG. 8,

FIG. 11 is a flowchart showing procedures in a common free game process shown in FIG. 10, and

FIG. 12 is a flowchart of a modification in which procedures in the bonus game process in the main process of FIG. 8 are changed.

### DETAILED DESCRIPTION OF THE PREFERRED EMBODIMENTS

Hereinafter, the embodiment of the present invention will be described. Here, the same numbers are used for the same elements and repetitious explanation will be omitted.

(Whole Construction of Slot Machine)

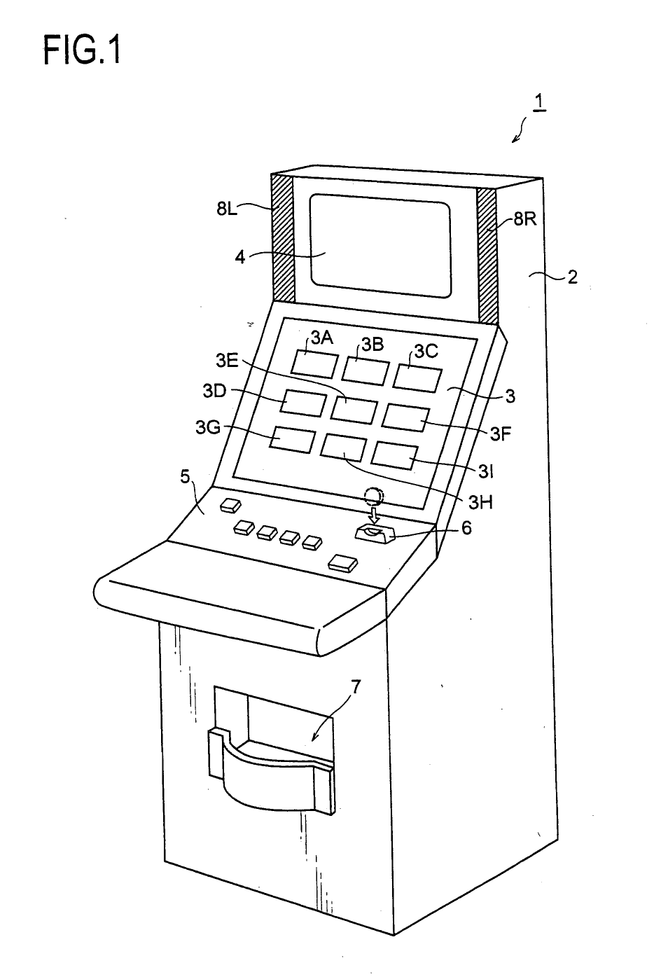

FIG. 1 is a perspective view showing whole construction of the slot machine 1. The slot machine 1 is indicated as the gaming machine according to the embodiment of the present invention, and the slot machine 1 has a plurality of variable display portions for variably displaying plural symbols and is constructed so that variable display games (slot games) can be done by variable display of the symbols displayed on each of the variable display portions. The slot machine 1 has a normal game mode in which a base game can be done among variable display games, the base game being unconditionally started from a game start, and additionally has both a special game mode and a specific game mode in which a bonus game can be done continuously to the base game under a predetermined condition. Further, in both the special game mode and the specific game mode, variable display games can be conducted.

The slot machine 1 has a main display 3 provided with a liquid crystal display device in front of a cabinet 2. And in the slot machine 1 a sub-display 4 with a liquid crystal display is arranged at an upper side of the main display 3. Further, speakers 8L, 8R to output sounds utilized for effect of the game are disposed at both left and right sides of the sub-display 4.

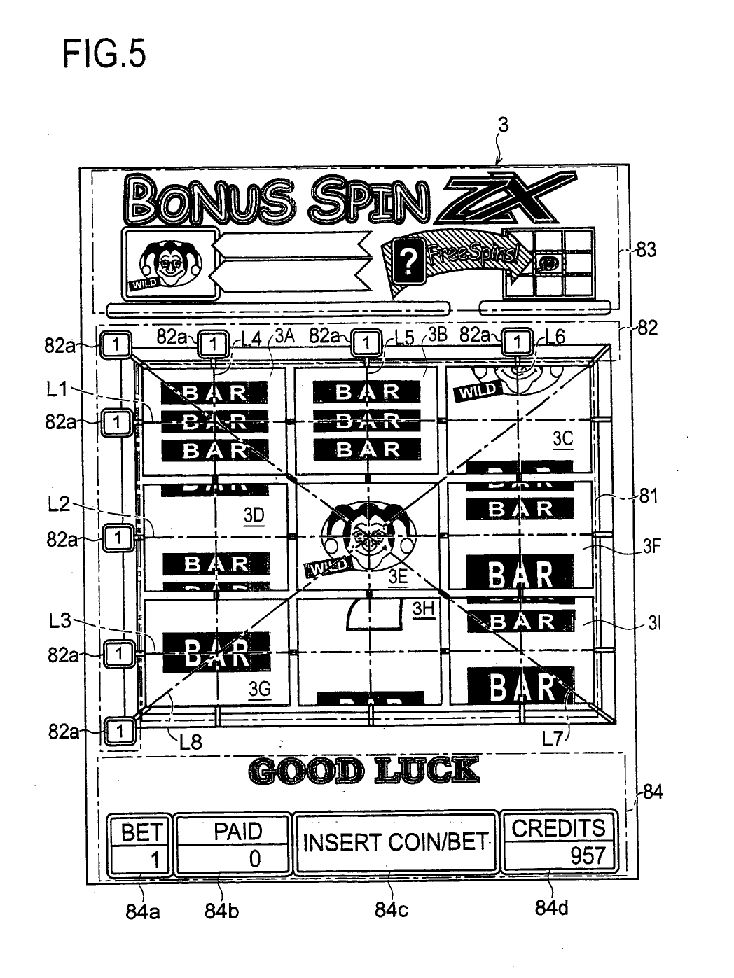

The main display 3 constructs a variable display device and has totally nine variable display portions 3A, 3B, 3C, 3D, 3E, 3F, 3G, 3H and 31, which are arranged in a matrix state of three vertical lines and three horizontal lines. In this main display 3, variable display images (reel images displayed as if the mechanical reels rotates) are displayed so that a plurality of symbols are scrolled in each of the variable display portions 3A˜31 while moving from an upper position toward a lower position, even in each of the normal game mode, the special game mode and the specific game mode. Here, as shown in FIG. 5, since the slot machine 1 has nine variable display portions 3A˜31, eight pay lines (L1˜L 8) may be set along three vertical lines, three horizontal lines and two diagonal lines.

On the sub-display 4 (see FIG. 1) images (for example, explanation of game contents), which are not directly concerned with the game, are displayed.

And in the slot machine 1, a control panel 5 and a coin insertion slot 6 to insert coins betted for the game are provided under the main display 3 and a coin tray 7 to receive coins paid out is arranged at a lower position of the cabinet 2.

On the control panel 5, there are provided a payout button 5a to instruct payout of coins, a collect button 5b to confirm coins obtained in the game, a maximum BET button (MAXBET) button 5c to bet maximum number of coins, a IBET button 5d to bet one coin, a repeat BET (REPEATBET) button 5e to instruct start of the game and a start (START) button 5f to input instruction of start of the game.

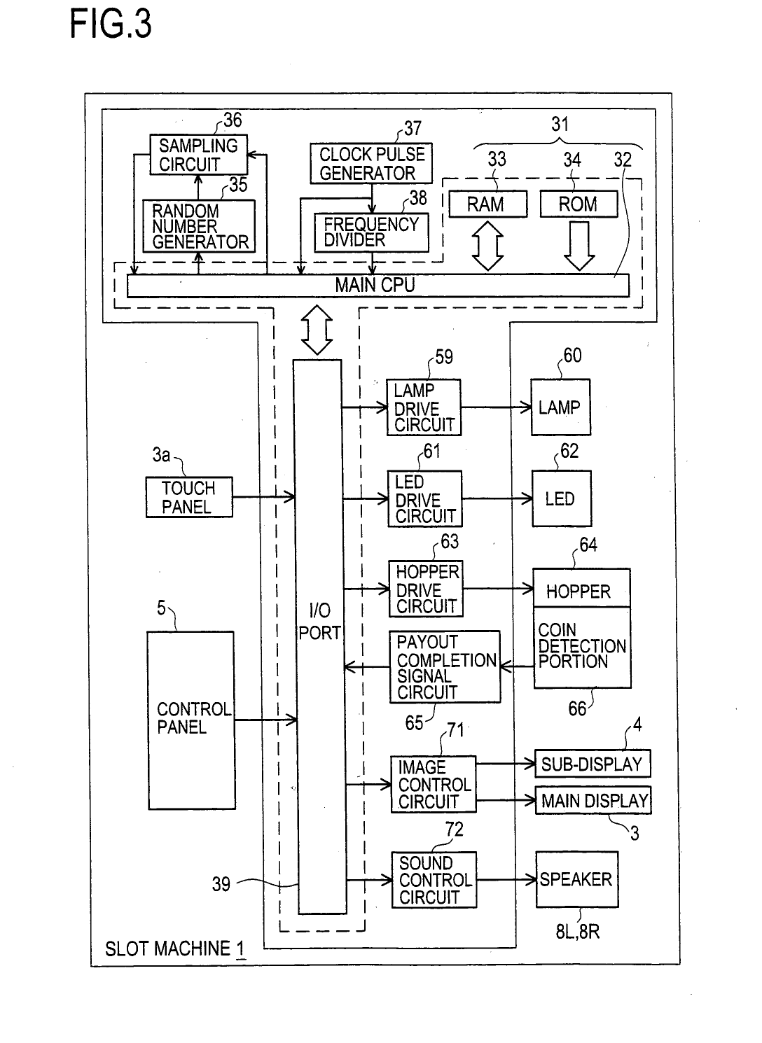

FIG. 3 is a block diagram mainly showing an inner construction of the slot machine 1. The slot machine 1 has a plurality of constructive elements including a microcomputer 31.

The microcomputer 31 is constructed from a main CPU (Central Processing Unit) 32, a RAM (Random Access Memory) 33 and a ROM (Read Only Memory) 34. The main CPU 32 operates according to programs stored in the ROM 34 and signals are input thereinto through a I/O port 39 from each of portions of the control panel 5, and contrarily, the main CPU 32 conducts input and output of signals between the other constructive elements, thereby conducts whole operation control of the slot machine 1. The RAM 33 stores data and programs utilized when the main CPU 32 operates. For example, random number values sampled by a sampling circuit 36 (mentioned later) are temporarily stored in the RAM 33 after the game is started. In the ROM 34, programs executed by the main CPU 32 and permanent data are stored.

And the slot machine 1 has a random number generator 35, a sampling circuit 36, a clock pulse generator 37 and a frequency divider 38. The random number generator 35 operates according to instruction by the main CPU 32 and generates random numbers within a predetermined range. The sampling circuit 36 extracts a voluntary random number among the random numbers generated by the random number generator 35 according to instruction by the main CPU 32 and inputs the random number extracted to the main CPU 32. The clock pulse generator 37 generates standard clock pulses to operate the main CPU 32 and the frequency divider 38 inputs a signal obtained by dividing the standard clock pluses with a constant frequency to the main CPU 32.

Further, the slot machine has a touch panel 3a, a lamp drive circuit 59, lamp 60, a LED drive circuit 61, LED 62, a hopper drive circuit 63, a hopper 64, a payout completion signal circuit 65 and a coin detection portion 66. And the slot machine 1 has an image control circuit 71 and a sound control circuit 72.

The touch panel 3a is arranged so as to cover a display plane of the main display 3 and detects positions where fingers of the player touch, further inputs position signals corresponding to the positions detected to the main CPU 32. The lamp drive circuit 59 outputs signals to turn on and off the lamp 60 to the lamp 60, thereby the lamp 60 is turned on and off while the game is executed. By turning on and off of the lamp 60, effect of the game is conducted. The LED drive circuit 61 controls turning on and off and displaying of the LED 62. The LED 62 conducts display of a number of credit and a number of coins obtained. The hopper drive circuit 63 drives the hopper 64 according to control by the main CPU 32, and the hopper 64 conducts operation to pay out coins corresponding to the winning prize and pays out coins to the coin tray 7 from a coin payout opening. The coin detection portion 66 counts a number of coins paid out from the hopper 64 and transmits data of the coin number which is counted to the payout completion signal circuit 65. The payout completion signal circuit 65 receives the data of the coin number transmitted from the coin detection portion 66 and transmits a coin payout signal to the main CPU 32 when the coin number reaches to predetermined number data.

The image control circuit 71 controls image displaying on each of the main display 3 and the sub-display 4, thereby displays various images such as variable display images constructing from plural symbols on the main display 3 and the sub-display 4.

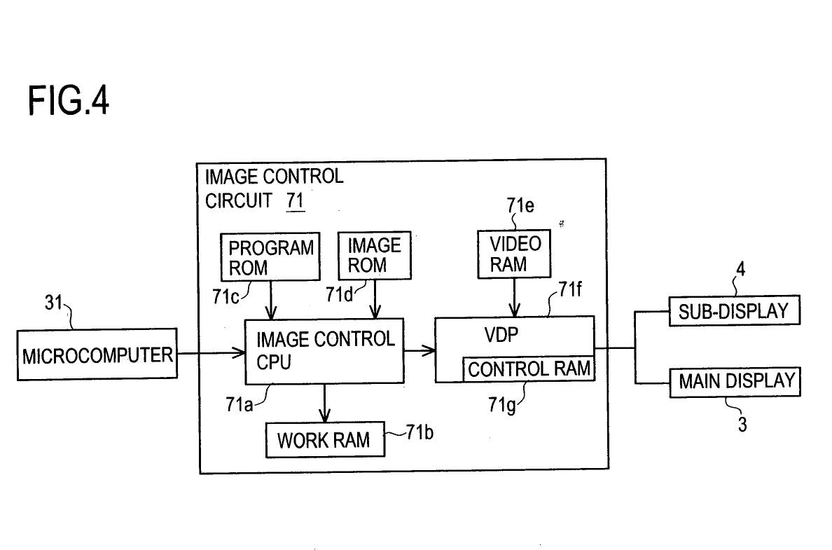

This image control circuit 71 has, as shown in FIG. 4, an image control CPU 71a, a work RAM 71b, a program ROM 71c, an image ROM 71d, a video RAM 71e and a VDP (Video Display Processor) 71f. The image control CPU 71a determines images (reel images, images of stop symbols displayed when scroll display is stopped) displayed on the main display 3 and the sub-display 4, according to the image control program (concerning with display on the main display 3 and the sub-display 4) stored beforehand in the program ROM 71c, based on parameters set by the microcomputer 31. the work RAM 71b is constructed as a temporary memory utilized when the image control program is executed by the image control CPU 71a.

The program ROM 71c stores image control programs and various selection tables. The image ROM 71d stores dot data to form images. In the dot data, according to the embodiment, symbol image data indicating each of the symbols utilized in the base game and the bonus game are included. The video RAM 71e is constructed as a temporary memory used when images are formed by the VDP 71f. The VDP 71f has a control RAM 71g and forms images corresponding to display contents of the main display 3 and the sub-display 4, the display contents being determined by the image control CPU 71a. Further, the VDP 71f outputs images formed thereby to the main display 3 and the sub-display 4.

The sound control circuit 72 (see FIG. 3) inputs sound signals for outputting sounds from the speakers 8L, 8R to the speakers 8L, 8R. From the speakers 8L, 8R, for example, sounds to raise interest for games are output at a voluntary timing after the game is started.

(Operation Contents of Slot Machine)

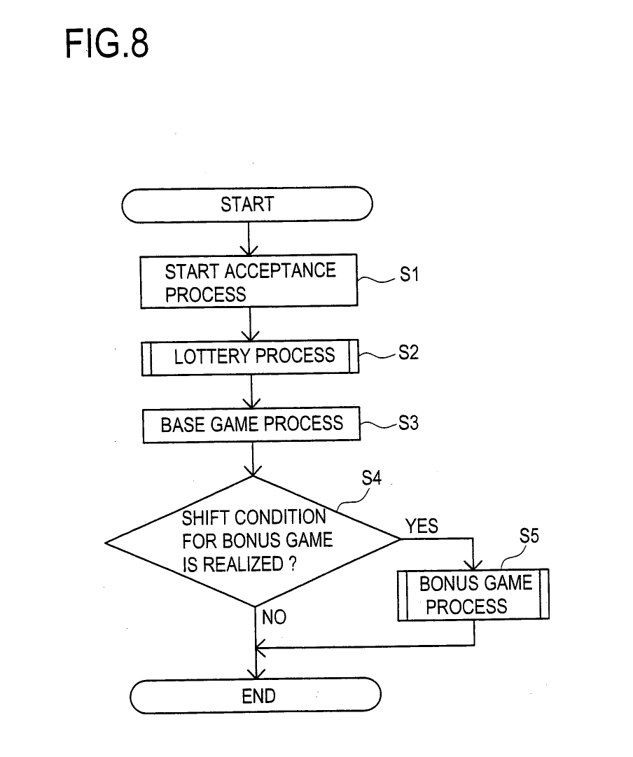

Next, operation contents of the slot machine 1 constructed according to the above will be described with reference to flowcharts shown in FIGS. 8 through 11. In the slot machine 1, as shown in FIG. 8, the base game is executed at first and the bonus game is continuously executed under a predetermined condition characterized by the present invention.

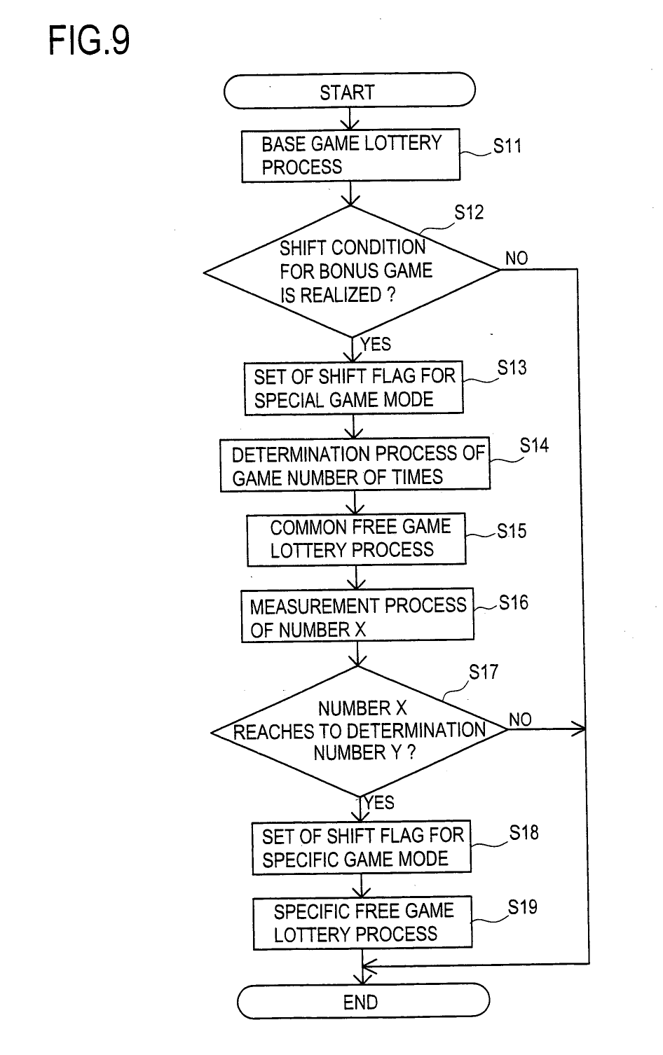

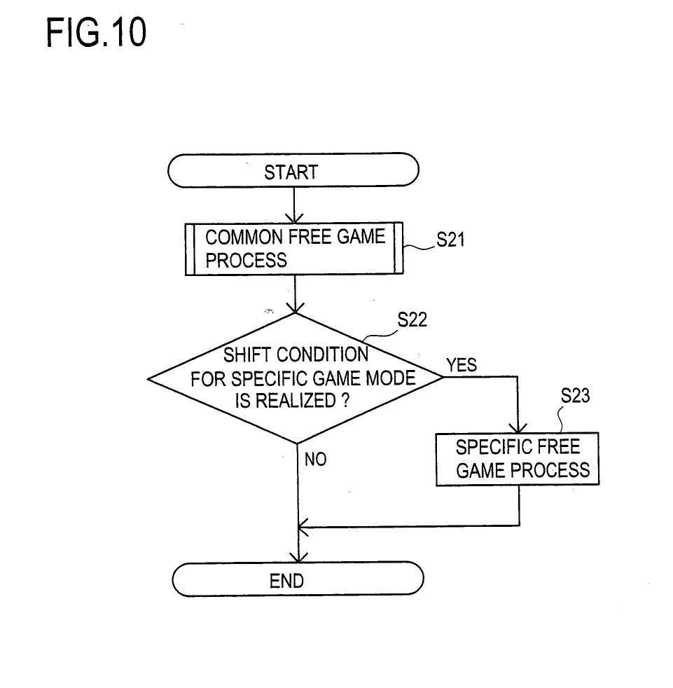

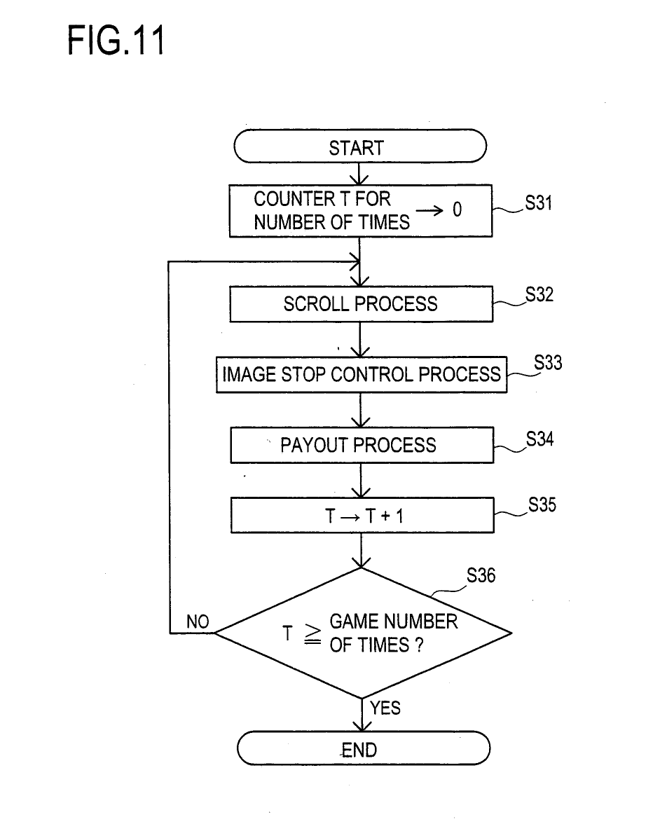

FIG. 8 is a flowchart showing procedures in a main process conducted from a game start to a game termination in the slot machine, the procedures being shown by blocks divided into each procedure, and FIG. 9 is a flowchart showing procedures in the lottery process. And FIG. 10 is a flowchart showing procedures in a bonus game process and FIG. 11 is a flowchart showing procedures in a common free game process. Here, in FIGS. 8 through 11, step is abbreviated as “S”.

In the slot machine 1, the main CPU 32 operates as a game progressing control device and controls progress of the game. At that time, in the slot machine 1, as shown in FIG. 8, when the main process is started, a start acceptance process is conducted in step (abbreviated as “S” hereinafter) 1 at the start of the game. And in S2, the lottery process is done. Next, in S3, the base game process is conducted while the game mode is retained to the normal game mode, thereafter procedure shifts to S4. In S4, based on a lottery result of the lottery process in S2, the main CPU 32 determines whether or not a condition to shift to the bonus game (shift condition) is realized. Here, if the shift condition is realized, procedure shifts to S5. On the contrary, if the shift condition is not realized, the main process is terminated. In the bonus game process in S5, an operation process to conduct a specific free game in the specific game mode is executed, in addition to a common free game in the special game mode. After the bonus game process is done, the main process is terminated. Hereinafter, procedures in each of the blocks in the flowchart will be described.

At first, when procedure shifts to the start acceptance process in S1, the slot machine 1 accepts operation to start the game by the player according to control by the main CPU 32. First, in order to start the base game, the player inserts coins to bet for one game into the coin insertion slot 6. Or the player operates the 1 BET button 5d or the maximum BET button 5c when credits remains. Next, the player conducts operation (hereinafter, such operation is called as “start operation”) of the start button 5f or the repeat BET button 5e. Based on this start operation, a start signal is input to the main CPU 32 from the start button 5f and the like.

Next, procedure shifts to S2 and the lottery process is done according to the flowchart shown in FIG. 9. When the lottery process is started, procedure shifts to S11 and the lottery process for the base game is done. In this base game lottery process, the main CPU 32 operates as a symbol determination device and the stop symbols utilized in the base game are determined among the symbols (stop symbols) stopped and displayed in each of the variable display portions 3A˜3I after variable display is stopped. Here, in the slot machine 1, while the lottery process is conducted, the main CPU 32 instructs the image control circuit 71 so that images for game effect are displayed on the sub-display 4.

And in the base game lottery process, when the main CPU 32 detects game start operation by the player based on the start signal from the start button 5f and the like, the main CPU 32 instructs to the random number generator 35 so as to generate random numbers within a predetermined range based on that the game start operation is detected (that is to say, based on a trigger of the game start). And the main CPU 32 instructs the sampling circuit 36 so as to extract a voluntary random number among the random numbers generated through the random number generator 35. When the random number is extracted, the main CPU 32 sets the random number to a search key and refers a symbol determination table (table in which code numbers of the symbols and the random numbers are concerned with each other and stored) stored in the ROM 34, thereby the main CPU 32 obtains the code number corresponding to the random number extracted.

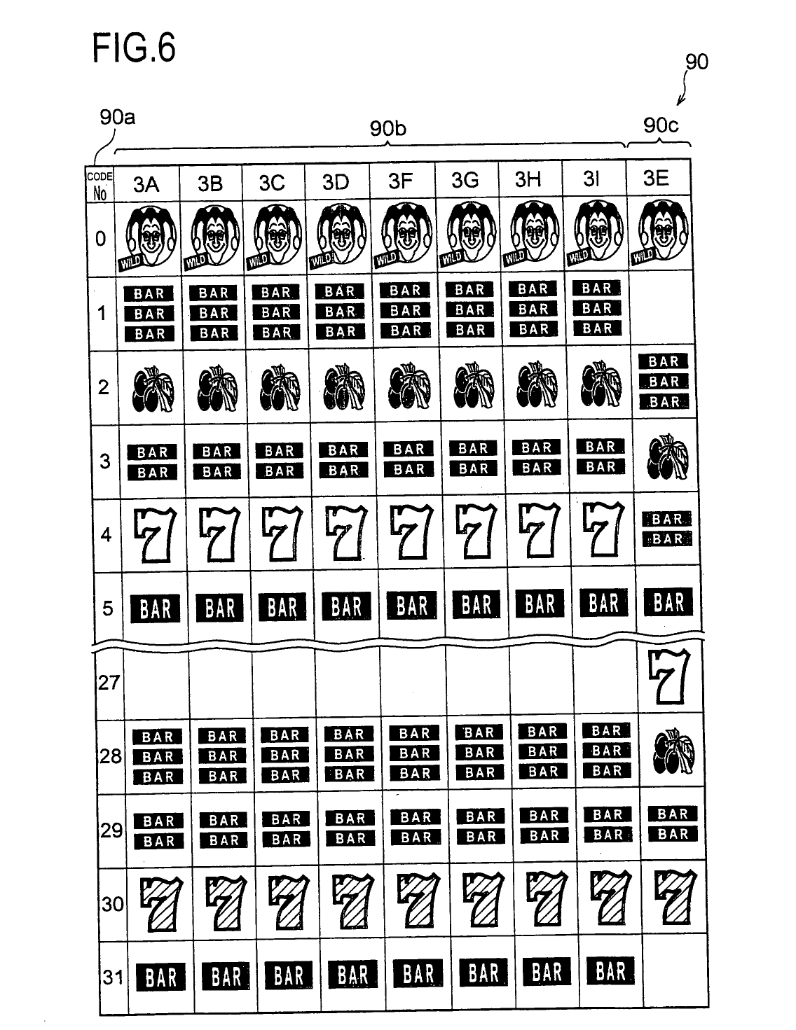

Next, the code number obtained is set to the search key and a stop table 90 shown in FIG. 6 is referred, thereby the stop symbols are determined displayed in each of the variable display portions 3A˜3I. Here, as shown in FIG. 6, the stop table 90 is a table that a code No. area 90a storing the code numbers of the symbols and first and second symbol areas 90b, 90c storing the symbols corresponding to each of the code numbers are provided.

In the first symbol area 90b and the second symbol area 90c, the symbol (code number thereof) is stored corresponding to each of the code numbers “0”˜“31”. And in the first symbol area 90b, the stop symbols (code numbers thereof) to stop and display in each of the variable display portions 3A˜3D, 3F˜3I except for the central variable display portion 3E are stored, and in the second symbol area 90c, the symbols (code numbers thereof) to stop and display in the central variable display portion 3E are stored. Further, in the first and second symbol areas 90b, 90c, the symbol corresponding to the code number “0” is “WILD joker”. This “WILD joker” means a symbol which is more beneficial for the player than the other symbols, and as shown in FIG. 6, the “WILD joker” is constructed by combining an image showing a face of a doll and charter line “WILD”.

After the stop symbols are determined for all of the variable display portions 3A˜3I, the main CPU 32 determines whether or not the winning prize is realized in all of the pay lines L1˜L8 by referring a winning prize determination table. In the winning prize determination table, the symbol patterns with the winning prize and the symbol patterns without the winning prize are stored corresponding to the combination of the code numbers so as be able to mutually distinguish the symbol patterns with the winning prize and the symbol patterns without the winning prize. If it is determined that the winning prize is realized, a prize mode determination process to determine a prize mode is conducted by referring a prize mode table, thereafter the base game lottery process is terminated. Here, the prize mode table is provided to determine a mode (prize mode) which is realized among various winning prizes and the payout corresponding to each of the prize modes is stored.

When procedure shifts to S12, the main CPU 32 operates as a shift determination device and determines whether or not the shift condition to shift the game mode from the normal game mode to the special game mode is realized. If it is determined that the shift condition is realized, procedure shifts to S13, and if it is determined that the shift condition is not realized, the lottery process is terminated. The shift condition to shift the game mode from the normal game mode to the special game mode is determined based on the stop symbols in each of the variable display portions 3A˜3I and the combination of the stop symbols. In the embodiment, the shift condition is determined based on whether or not the stop symbol in the central variable display portion 3E becomes “WILD joker” which is mentioned later. That is, in the embodiment, the symbol “WILD joker” is a trigger symbol to realize the shift condition.

Of course, the shift condition may be determined based on whether or not the stop symbol becomes the symbol other than “WILD joker”. Here, since the symbol “WILD joker” indicates the symbol which is beneficial for the player in comparison with the other symbols, the player pays attention to the symbol “WILD joker” in many cases.

Therefore, when the game mode shifts to the special game mode based on that “WILD joker” is stopped and displayed, the player can easily recognize the shift state to the special game mode, thereby interest for games can be increased.

When procedure shifts to S13, a special shift flag to shift to the special game mode is set, thereafter procedure shifts to S14. In S14, the main CPU 32 operates as a determination device for determining a game number of times and conducts a determination process to determine a game number of times of the common free game. That is to say, the main CPU 32 instructs the random number generator 35 so as to generate random numbers within a predetermined range and instructs the sampling circuit 36 so as to extract a voluntary random number among the ransom numbers generated. After the random number is extracted, the main CPU 32 sets such random number to the search key and obtains the game number of times (for example, 5 times) of the common free game by referring the determination table to determine the game number of times (table in which the number of times of the common free game and the random number are concerned with each other and stored therein) stored in the ROM 34.

Thereafter, procedure shifts to S15 and a common free game lottery process is conducted. In the common free game lottery process, the main CPU 32 operates as a symbol determination device and conducts a determination process of the symbols stopped in each of the variable display portions 3A˜3I after the game mode shifts to the special game mode. That is, the main CPU 32 conducts the determination process of the stop symbols utilized in the common free game. Here, since the game number of times of the common free game is determined in the determination process of the game number of times in S14, the stop symbols utilized in the common free games corresponding to the game number of times determined in the above are determined.

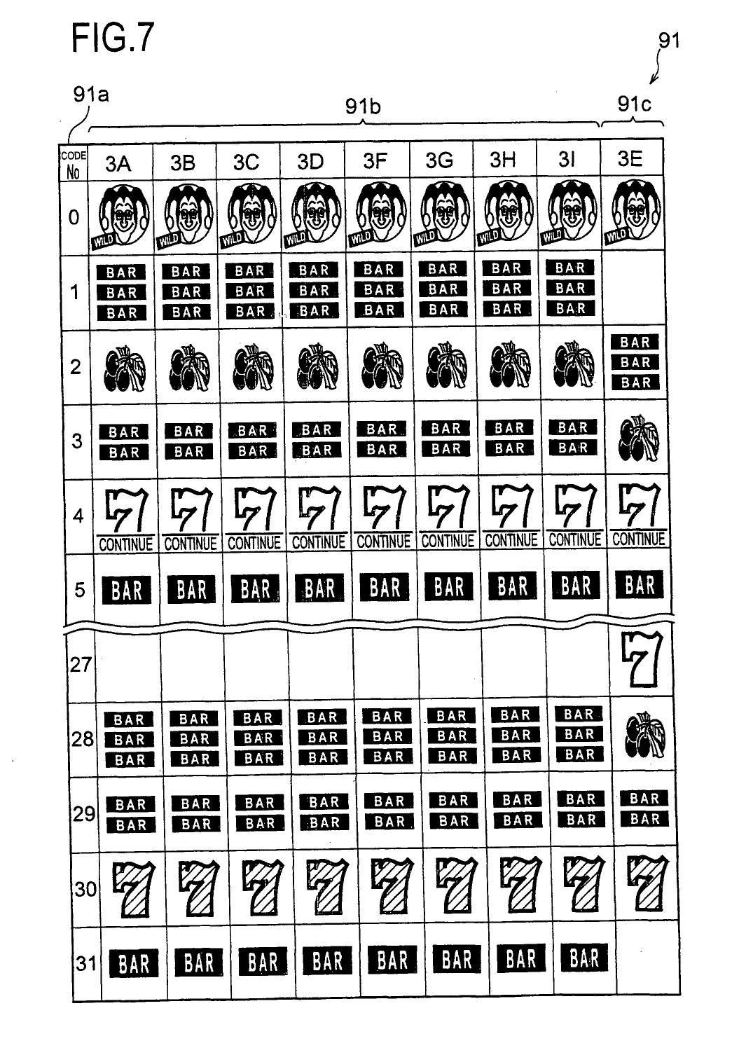

Also in the determination process of the stop symbols, similar to the determination process of the stop symbols in the base game lottery process, the main CPU 32 extracts a random number and retrieves the stop symbols stopped and displayed in each of the variable display portions 3A˜3I, with reference to the stop table 91 (table in which the code numbers of the symbols and the stop symbols are concerned with each other and stored) shown in FIG. 7 by utilizing the random number extracted. The symbols retrieved every each of the variable display portions 3A˜3I are determined as the stop symbols in each of the variable display portions 3A˜3I.

Here, the stop table 91 shown in FIG. 7 is as same as the stop table shown in FIG. 6. That is to say, as shown in FIG. 7, the stop table 91 has a code number area 91a for storing code numbers of the symbols and first and second symbol areas 91b, 91c for storing the symbols corresponding to each of the code numbers.

Here, in the embodiment, a symbol “7/CONTINUE” is provided as the symbol which is utilized only in the common free game. This symbol “7/CONTINUE” is a symbol corresponding to the code number “4” in the first and second symbol areas 91b, 91c and is not provided in the stop table (see FIG. 6) which is referred in the base game lottery process. In the embodiment, the symbol “7/CONTINUE” represents a specific stop symbol and the symbol “7/CONTINUE” is constructed from the number “7” and characters “CONTINUE” added to the number “7”, in order to make the player recognize that the symbol “7/CONTINUE” is a specific symbol.

As mentioned, the stop symbols utilized in the common free game are determined. After all stop symbols utilized in the common free game, the main CPU 32 operates as a prize determination device in the common free game and conducts a prize determination process in each of the common free games. In the prize determination process, it is determined for each of the pay lines L1˜L8 whether the winning prize is realized, and if the winning prize is realized, the winning prize mode thereof is determined. For example, the prize determination process in the common free game is done by the same process as the prize determination process executed in the base game lottery process (S11).

After procedure shifts to S16, the main CPU 32 operates as a number measurement device and conducts a number measurement process for measuring the number of the specific stop symbol which is stopped and displayed in each of the variable display portions 3A˜3I after the game mode shifts to the special game mode.

That is to say, the main CPU 32 reads out the code number from the RAM 33 and determines whether or not each of the code numbers read out corresponds to the code number “4” (see FIG. 7) set as the symbol “7/CONTINUE” (specific stop symbol). Further, the main CPU 32 counts up the number of times that the code number read out is determined as the code number “4”. This number of times measured according to the above corresponds to the number X of the specific stop symbol which is stopped and displayed in each of the variable display portions 3A˜3I.

Here, the specific stop symbol is not limited to the symbol “7/CONTINUE” and various symbols such as mere the number “7”, the other normal symbol, “WILD joker”, “SCATTER symbol” and the like may be used as the specific stop symbol. In this case, it is preferable that the specific stop symbol is set to the symbol with high payout as the winning prize among the normal symbols or the symbol more beneficial for the player than the normal symbol.

In S17, the main CPU 32 operates as a number determination device and determines whether or not the number X measured in S16 reaches to the determination number Y (for example, five or ten). That is, the main CPU 32 compares the number X measured in S16 with the determination number Y and if it is determined that the number X becomes more than the determination number Y, procedure shifts to S18. On the contrary, if it is determined that the number X is less than the determination number Y, the lottery process is terminated.

In S18, a specific flag to shift to the specific game mode is set and procedure shifts to S19. In S19, a lottery process in the specific free game is conducted. In the specific free game lottery process, the main CPU 32 operates as a device conducting the specific free game lottery process, and for example, the main CPU 32 conducts the same process as the common free game lottery process in S15. Here, in the embodiment, since the number of times of the specific free game is set to 5 (five) times, determination of the stop symbols utilized in all (five) specific free games, determination whether or not the winning prize is realized and determination of the prize mode are done in S19. However, the number of times of the specific free game may be voluntarily set, and for example, such number of times may be set to 5 times or 10 times. After the specific free game lottery process in S19 is terminated, procedure shifts to the base game process shown in FIG. 8.

After the base game process in S3 is started, a scroll process is done and images shown in FIG. 5 are displayed on the main display 3. Here, nine variable display portions 3A˜3I mentioned in the above are displayed on the main display 3. And at an upper side of the variable display portions 3A˜3I, the character line “BONUS SPIN” and a title display portion 83 to explain game contents are displayed. Further, at a lower side of the variable display portions 3A˜3I, it is displayed a meter display portion including a bet number display portion 84a, a paid number display portion 84b, a coin insertion and payout display portion 84c and a credit number display portion 84d. Here, eight bet number display portions 82a to display the bet number on each of the pay lines are arranged so as to enclose the periphery of the variable display portions 3A˜3I.

And after the game is started, the scroll process by which the symbols are variably displayed is conducted in each of the variable display portions 3A˜3I of the main display 3, according to the instruction from the main CPU 32.

Next, an image stop control process is conducted and the stop symbols corresponding to the lottery result in the lottery process (base game lottery process in S11) in S2 are stopped in each of the variable display portions 3A˜3I while gradually decreasing the scroll speed of the symbols. And if the winning prize is realized, coins corresponding to the winning prize are paid out. As mentioned, when the scroll process, the image stop control process and the coin payout process are terminated, the base game process is terminated.

After the base game process is terminated, procedure shifts to S4 and the main CPU 32 operates as a shift device to shift the game mode from the normal game mode to the special game mode. That is to say, the main CPU 32 determines whether or not the shift condition is realized, based on whether or not the special shift flag to shift the game mode to the special game mode is set. If it is determined that the special shift flag is set, procedure shift to the bonus game process in S5, and on the contrary, if it is determined that the special shift flag is not set, the main process is terminated. Here, in the image shown in FIG. 5, the stop symbol of the variable display portion 3E becomes “WILD joker” and therefore it is shown an image in a case that the shift condition to shift the game mode to the special game mode is realized in the base game.

When procedure shifts to the bonus game process in S5, the common free game process shown in S21 of FIG. 10 is conducted. In the common free game process, the main CPU 32 operates as a game control progress device and controls process of the common free game. That is, the main CPU 32 controls progress of the common free game so that the common free game is repeated according to the number of times determined in the determination process of the game number of times in S14.

In this case, the main CPU 32 conducts initialization that the counter T to count number of times is set to 0 (zero) in S31 shown in FIG. 11, thereafter procedure shifts to S32.

In S32, it is conducted the scroll process in which a plurality of symbols are variably displayed in each of the variable display portions 3A˜3I having a matrix construction of 3 vertical lines and 3 horizontal lines. That is, the main CPU 32 instructs the image control circuit 71 so that the symbol images utilized in the common free game in the first time are variably displayed on the main display 3. The symbols variably displayed are the symbols corresponding to the stop table 92 shown in FIG. 7.

Next, procedure shifts to S33 and the image stop control process is done. That is, the main CPU 32 inputs to the image control circuit 71 an instruction to display the stop symbols based on the lottery result in the lottery process in S2 in each of the variable display portions 3A˜3I. Thereafter, the image control circuit 71 reads out the symbol data corresponding to the stop symbols from the image ROM 71d and displays the stop symbols in every each of the variable display portions 3A˜3I.

In S34, the coin payout process is executed, thereby coins based on the result of the lottery process (determination of the winning prize mode) in S2 are paid out. That is, the main CPU 32 instructs the hopper drive circuit 63 to pay out coins according to the number determined in the lottery process in S2, thereby coins are paid out from the hopper 64. Next, procedure shifts to S35 and 1 (one) is added to the counter T.

Next, in S36, it is determined whether or not the counter T reaches to the game number of times based on the determination process to determine the game number of times in S14, and if it is determined that the counter T does not reach to the above game number of times, procedure returns to S32, thereafter a series of procedures mentioned above are repeated. On the contrary, if it is determined that the counter T reaches to the above game number of times, the common free game process is terminated.

After the common free game is terminated, procedure shifts to S22 shown in FIG. 10, and the main CPU 32 operates as a specific shift device. The main CPU 32 determines whether or nor the shift condition is realized, based on whether or not the specific shift flag to shift the game mode to the specific game mode is set. And if it is determined that the specific shift flag is set, the game mode is shifted to the specific game mode and the specific free game process in S23 is conducted. On the contrary, if it is determined that the specific shift flag is not set, the bonus game process is terminated.

In the specific free game process in S23, the same process as that of the common free game is basically done, That is, as shown in FIG. 11, the initialization process of the counter, the scroll process, the image stop control process, the payout process, the adding process of the counter and the determination process whether or not the counter reaches to the specific game number of times, are executed. Here, the specific game number of times of the specific free game according to the embodiment is not determined by the lottery process, but is set beforehand as 5 (five) times. Therefore, after the specific free games of five times are terminated, the main process is terminated.

Here, the game number of times of the specific free game (specific game number of times) is not limited to 5. For example, the specific game number of times may be set to only one time. And the specific game number of times to conduct the specific free game may be determined by the lottery process. Further, based on the result of the number X measured in S16, the specific game number of times of the specific free game may be determined. For example, the above mentioned number X may be set to the specific game number of times. Furthermore, the game conducted in the specific game mode may be made different from the common free game. For example, such game may be the game in which the winning prize is obtained if trump images or images of mah-jong tiles are variably displayed and the winning combination is aligned.

As mentioned above, in the slot machine 1, when the specific stop symbol (for example, “7/CONTINUE”) with a predetermined number (determination number) is displayed, the specific free game is conducted, therefore the shift to the specific game mode is done according to a different display mode from that of a case that the game mode conventionally shifts from the base game to the free game. Thereby, such shift to the specific game mode is done even if the special symbols are not aligned on the pay line, as a result, novel game characteristic different from the conventional game characteristic can be obtained.

And since the player usually counts the number of times that the specific stop symbol appears, with high expectation as if the game mode shifts to the specific game mode, interest of the common free game in the special game mode, such free game being apt to be monotonous and simple, can be raised.

And in the embodiment, after the common free game is conducted in a predetermined number of times (in the embodiment, the game number of times), the game mode shifts from the special game mode to the specific game mode. Therefore, after enjoying the common free game done in the special game mode in a predetermined number of times, the player can further enjoy the specific free game in the specific game mode, as a result, satisfaction of the player can be increased. Further, in the embodiment, since the game number of times according to which the common free game is conducted in the special game mode is determined by the lottery process, the number of times of the common free game done in the special game mode can be changed every the game mode shifts to the special game mode. Thus, the player can feel change in the common free game which is apt to become monotonous in the special game mode and can feel more interest for games.

Next, it will be described a case (abbreviated as “modification” hereinafter) that a part of operation procedures of the slot machine 1 mentioned above is modified. Here, in explanation of operation procedures according to the modification, the same process as the procedures already explained will be omitted.

Even in the modification, as shown in FIG. 8, after the start acceptance process in S1 is done, procedure shifts to the lottery process in S2. After the lottery process in S2 is terminated, procedure shifts to S11 in FIG. 9 and the base game lottery process is conducted. And after the base game lottery process is terminated, procedure shifts to S3, without conducting operation procedures in S12˜S19. In S3, the base game process is done, similarly to the case mentioned above. And in S4, it is determined whether or not the shift condition is realized. If it is determined in S4 that the shift condition is realized, procedure shifts to the bonus game process in S5, and on the contrary, if it is determined in S4 that the shift condition is not realized, the main process is terminated. Here, as for a predetermined number of times of the common free game conducted in the bonus game process, such predetermined number of times is not determined by the lottery process but is fixed to 5 (five) times beforehand.

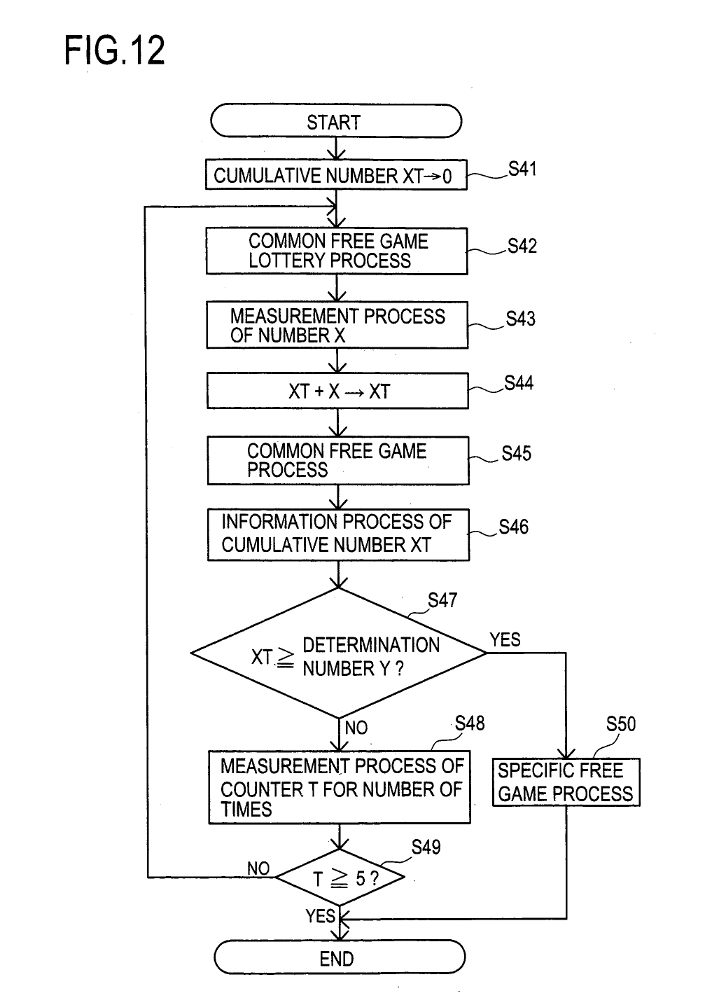

After procedure shifts to the bonus game process in S5, procedure shifts to S41 shown in FIG. 12. In S41, initialization to set a cumulative number XT of the specific symbol to “0” (zero) is done. Thereafter, procedure shifts to S42 and the common free game lottery process is conducted. In the common free game lottery process, determination of the stop symbols utilized in one common free game and the winning prize determination process of one common free game are executed. After the lottery process of one common free game is terminated, procedure shifts to S43.

In both S43 and S44, the main CPU 32 operates as a number measurement device. That is to say, it is conducted the measurement process of the number X of the specific stop symbol (for example, “7/CONTINUE”) stopped and displayed in each of the variable display portions 3A˜3I among the stop symbols determined as the symbols utilized in one common free game in S43. And in S44, the number X measured every the common free game is accumulated and the cumulative number XT of the specific stop symbol is obtained. After the cumulative number XT is obtained, procedure shifts to S45. Here, in S44, every the process to obtain the cumulative number XT is terminated, it is conducted initialization that the number X is reset to 0 (zero).

In S45, the common free game process is done. After one common free game process is terminated, procedure shifts to S46 and information process to inform the cumulative number XT is conducted. In this case, the main CPU 32, the image control circuit 71 and the sub-display 4 cooperatively operate as an information device.

That is, the main CPU 32 instructs the image control circuit 71 so as to display images indicating contents of the cumulative number XT and the image control circuit 71 displays figure images indicating contents of the cumulative number XT on the sub-display 4. For example, the cumulative number XT may be displayed as “1”, “2”, “3” . . . . Instead, as the cumulative number XT, it may be displayed the value obtained by subtracting the cumulative number XT from the determination number Y which is set to the shift condition to the specific game mode. In this case, for example, such value is displayed as “9”, “8”, “7” . . . .

And images of the cumulative number XT are not limited to figure images, and for example, such images may be displayed as follows. That is, block images are piled according to increase of the cumulative number XT and when the block images reach to a predetermined height, the game mode shifts to the specific game mode. Further, the information device of the cumulative number XT is not limited to the device that only displays images. For example, such information can be done by sounds output from the speakers 8L, 8R and can be done by combining images and sounds. And it can be done effect that an image of fuse one end of which is fired is displayed and explosion sounds are output when the game mode shifts to the specific free game. In this case, the sound control circuit 72 and the speakers 8L 8R operate as a part of the information device. Based on information by the information device, the player expects that the game mode shifts to the specific free game corresponding to the specific game mode. Thereby, expectation to shift to the specific game mode during the special game mode can be raised and effect to increase interest for games can be done. After information by the information device is terminated procedure shifts to S47.

After procedure shifts to S47, the main CPU 32 operates as a number determination device and determines whether or not the cumulative number XT reaches to the determination number Y. And the main CPU 32 operates as a specific shift device and shifts the game mode form the special game mode to the specific game mode. That is, the main CPU 32 compares the cumulative number XT with the determination number Y and if it is determined that the cumulative number XT is more than the determination number Y, the specific free game process in S50 is conducted. After the specific free game process is terminated, the main process is terminated. On the other hand, if it is determined that the cumulative number XT is less than the determination number Y, procedure shifts to S48.

In S48, the main CPU 32 measures the counter T of the common free game in the special game mode, and after measurement of the counter T is terminated, procedure shifts to S49.

In S49, it is determined whether or not the counter T measured in S48 reaches to 5 (five) times, and if it is determined that the counter T reaches to 5 times, the bonus game process is terminated, thereafter the main process is terminated. On the other hand, if it is determined that the counter T of the common free game does not reach to 5 times, procedure returns to the common free game lottery process in S 42, thereafter a series of procedures are repeated. Here, the number of times according to which the common free games are conducted can be voluntarily set and it is enough that such number of times corresponds to plural number of times.

As mentioned, in the modification of the slot machine 1, in a case that the specific stop symbol (for example, “7/CONTINUE”) with a predetermined number (determination number) is displayed, the specific free game is conducted. Thereby, the shift to the specific game mode is done according to a different display mode from that of a case that the game mode conventionally shifts from the base game to the free game. Thereby, such shift to the specific game mode is done even if the special symbols are not aligned on the pay line, as a result, novel game characteristic different from the conventional game characteristic can be obtained.

And since the player usually counts the number of times that the specific stop symbol appears, with high expectation as if the game mode shifts to the specific game mode, interest of the common free game in the special game mode, such free game being apt to be monotonous and simple, can be raised.

And in the slot machine 1 according to the embodiment, since the game mode shifts to the specific game mode without waiting termination of the common free game in five number of times, it can be realized effect that speedy and sharp game feeling is given to the player, thereby interest for games can be increased.

Further, according to the slot machine 1 of the embodiment, since the information device is provided, it can inform to the player that there exists possibility to shift the specific game mode while the game (for example, the common free game) is conducted. Therefore, the player can enjoy the game done in the special game mode while expecting the shift to the specific game mode, as a result, interest for games can be increased.

Although the slot machine 1 is explained based on the embodiment, the present invention is not limited to the embodiment mentioned above. For example, although in the embodiment it is described the video slot machine in which the symbols are variably displayed in each of the variable display portions 3A˜3I, the present invention can be adopted to the slot machine in which the mechanical reels are rotated and the symbols formed on each of the reels are variably displayed. In this case, the number of the reel can be voluntarily set. For example, the number of the reel may be “9”, “5”, “3” and the other number.

What is claimed is:

1. A gaming machine comprising:
a variable display device having a plurality of variable display portions in each f which a plurality of symbols are variably displayed;
a symbol determination device for determining stop symbols each of which is topped in each of variable display portions;
a shift determination device for determining whether or not a shift condition to shift a game mode from a normal game mode to a special game mode is realized; and
a shift device for shifting the game mode from the normal game mode to the special game mode based on a determination result determined by the shift determination device;
the gaming machine further comprising:
a number measurement device for measuring a number of a specific stop symbol which is stopped and displayed in each of the variable display portions among the stop symbols determined by the symbol determination device after the game mode shifts to the special game mode; and
a number determination device for determining whether or not the number of the specific stop symbol measured by the number measurement device reaches to a predetermined determination number; and
a specific shift device for shifting the game mode from the special game mode to a specific game mode when the number determination device determines that the number of the specific stop symbol reaches to the predetermined determination number.

2. The gaming machine according to claim 1, further comprising:
a first stop symbol lottery table including a trigger symbol for determining the stop symbols in the normal game mode;
a second stop symbol lottery table including the specific stop symbol for determining the stop symbols in the special game mode;
wherein the symbol determination device determines the stop symbols in the normal game mode with reference to the first lottery table; and
wherein the symbol determination device determines the stop symbols in the special game mode with reference to the second lottery table.

3. The gaming machine according to claim 2, wherein the shift determination device determines that the shift condition is realized when the trigger symbol stops in the variable display portion which is set beforehand among the variable display portions.

4. The gaming machine according to claim 1, further comprising:
a determination device for determining a game number of times according to which a game is conducted in the special game mode;
wherein the determination device determines the game number of times through a lottery process.

5. The gaming machine according to claim 4, wherein the specific shift device shifts the game mode from the special game mode to the specific game mode after the game is conducted in the special game mode according to the game number of times determined by the determination device, in a case that the number determination device determines that the number of the specific stop symbol reaches to the predetermined determination number.

6. The gaming machine according to claim 4, further comprising:
a game progress control device for controlling progress of the game conducted in the special game mode so as to repeat the game according to the game number of times determined by the determination device.

7. The gaming machine according to claim 1, further comprising:
an information device for informing the number of the specific stop symbol measured through the number measurement device.

8. The gaming machine according to claim 1, further comprising:
a determination device for determining a game number of times according to which a game is conducted in the special game mode;
wherein the specific shift device shifts the game mode from the special game mode to the specific game mode even before the game is conducted in the special game mode according to the game number of times determined by the determination device, in a case that the number determination device determines that the number of the specific stop symbol reaches to the predetermined determination number.

9. The gaming machine according to claim 1, wherein the number determination device determines whether or not the number of the specific stop symbol reaches to the predetermined determination number before the game is conducted in the normal game mode.

10. A gaming method comprising steps of:
variably displaying a plurality of symbols in each of a plurality of variable display portions of a variable display device;
determining stop symbols stopped in each of the variable display portions;
determining whether or not a shift condition to shift a game mode from a normal game mode to a special game mode is realized;
shifting the game mode from the normal game mode to the special game mode based on a determination result determined in the determining step of the game mode;
measuring a number of a specific stop symbol which is stopped and displayed in each of the variable display portions among the stop symbols determined in the determining step of the stop symbol after the game mode shifts to the special game mode;
determining whether or not the number of the specific stop symbol measured in the measuring step reaches to a predetermined determination number; and
shifting the game mode from the special game mode to a specific game mode when it is determined in the determining step of the number of the specific stop symbol that the number of the specific stop symbol reaches to the predetermined determination number.
